(19) United States
(12) Patent Application Publication
(10) Pub. No.: US 2026/0288696 A1
(43) Pub. Date: Sep. 24, 2026

(54) Methods and Systems for Updating a Graph Data Structure

(71) Applicant: Xero Limited, Te Aro, Wellington (NZ)

(72) Inventors: Rebecca Dridan, Te Aro, Wellington (NZ); Jiun Siew, Te Aro, Wellington (NZ); Karl Grieser, Te Aro, Wellington (NZ); Brendan Law, Te Aro, Wellington (NZ); Jane Fraser, Te Aro, Wellington (NZ); Shannon Pace, Te Aro, Wellington (NZ)

(21) Appl. No.: 19/469,196

(22) PCT Filed: Mar. 28, 2024
(86) PCT No.: PCT/NZ2024/050035

§ 371 Date: Sep. 25, 2025

(30) Foreign Application Priority Data
Mar. 31, 2023 (AU) 2023900913

(51) Int. Cl. G06F 16/23; G06F 16/21; G06F 16/901

(52) U.S. Cl. CPC G06F 16/23; G06F 16/213; G06F 16/9024

(57) ABSTRACT

A method comprises determining a target object read request for querying a first data structure, the target object read request comprising a target identifier of a target object, determining a first object identifier of a first object based on the target identifier, providing a response to the target object read request, wherein the response includes at least the first object, determining association information between the first object and a second object, and determining whether the association information between the first object and the second object is stored in a second data structure. The method further comprises, responsive to no association information being identified, generating new association information indicative of the association between the first entity object and the second entity object, the new association information including the first identifier and a second identifier, generating an association write request to write the new association information to the second data structure.

### CROSS-REFERENCE TO RELATED APPLICATION(S)

This application is a national stage 371 application of International Patent Serial No. PCT/NZ2024/050035, filed on Mar. 28, 2024, which claims priority to and the benefit of Australian Patent Application Serial No. 2023900913, filed Mar. 31, 2023, the entire disclosures of which are hereby incorporated by reference.

### TECHNICAL FIELD

Embodiments generally relate to methods, systems, and computer-readable media for updating a graph data structure, and in some embodiments, for updating the graph data structure through the use of services and/or products.

### BACKGROUND

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a method comprising: determining a target object read request for querying a first data structure, the target object read request comprising a target identifier of a target object; determining a first object identifier of a first object in the first data structure based on the target identifier; providing a response to the target object read request, wherein the response includes at least the first object; determining association information between the first object and a second object; determining whether the association information between the first object and the second object is stored in a second data structure; and responsive to no association information being identified between the first object and the second object in the second data structure: generating new association information indicative of the association between the first entity object and the second entity object, the new association information including the first identifier of the first object and a second identifier of the second object; generating an association write request to write the new association information to the second data structure; providing the association write request to the second data structure.

In some embodiments, responsive to determining that there is no first object identifier associated with the target identifier in the first data structure, determining an object identifier using a fuzzy matching technique to determine a similarity score between the target identifier and an object identifier, and identifying the object identifier as being associated with the target identifier when the similarity score is above a threshold value.

After providing a response to the target object read request including the first object, the method may further include: performing validation that the first object corresponds with the target object.

In some embodiments, the first and/or second data structures may be graph structures. The first data structure may be a business register. The business register may comprise at least one canonical first object and a set of alias associated with the at least one first object.

In some embodiments, determining the first object identifier based on the target identifier may comprise comparing the target identifier with the at least one canonical first object and/or the set of aliases associated with the at least one first object. Determining the target object read request may comprise: receiving the target object read request from a transaction reconciliation module; and providing the response to the target object read request comprises sending the response to the transaction reconciliation module to allow the transaction reconciliation module to reconcile a transaction using the first object.

The second data structure may be in communication with the first data structure. The target object identifier may be extracted from an external data source. The first object and/or the second object may be an entity object, and the target object identifier may be a candidate entity attribute.

The first object may be a contact object. The second object may be an organisation object. The step of determining whether the association information between the first object and the second object is stored in a second data structure, may comprise: generating an association read request, the association read request comprising target association information between the first object and the second object, the target association information including first and second identifiers of the respective first and second objects; identifying one or more edge tables in the second data structure that include the target association information; wherein responsive to no edge tables being identified within the second data structure that include the target association information, determining no association information between the first object and the second object is stored in the second data structure; and responsive to one or more edge tables being identified within the second data structure that include the target association information, determining association information between the first object and the second object is stored in the second data structure; and returning at least the first object.

In some embodiments, the step of identifying one or more edge tables in the second data structure that include the target association information may include: querying all edge tables in the second data structure that include at least the first identifier to determine if the edge tables contain the second identifier. The target association information may include a target association identifier indicating an association type. The target association identifier may be a contact association type.

In some embodiments, the method may further include the step of: responsive to association information being identified between the first object and the second object in the second data structure, providing a response containing the association information and the first entity object. The step of generating new association information indicative of the association between the first object and the second object may include: inferring that the first object is associated with the second object by an inferred association type based on the target object read request. The inferred association type may be a contact association type.

Providing the association write request to the second data structure may comprise: providing the association write request to a write interface in communication with the second data structure for writing to one or more tables of the second data structure. The association write request may include a plurality of association write requests. The step of providing the association write request to the write interface may comprise: determining a plurality of association write requests to be written to the graph structure; collating the plurality of association write requests as a batch write request; and providing the batch write request to the write interface of the graph interface module.

In some embodiments, the method may further comprise: writing the new association information to the second data structure by: determining first and second object keys from the respective first and second objects; writing the first and second object keys to an edge table of the second data structure, the edge table being indicative of the association between the first object and the second object. The first and second keys may be extracted from first and second tables of the respective first and second objects. The first object identifier and/or the second object identifier may be an entity identifier. The entity identifier may be a string value.

The method may further include the step of determining a target object based on a request from a user via a user interface. The user interface may be a user interface provided by an accounting platform.

Some embodiments relate to a method comprising: determining a target object read request for querying a business register, the target object read request comprising a target entity identifier of a target entity object; determining a first entity object identifier of a first entity object in the business register based on the target entity identifier; providing a response to the target object read request, wherein the response includes at least the first entity object; determining association information between the first entity object and a second entity object; determining whether the association information between the first object and the second object is stored in a graph data structure; and responsive to no association information being identified between the first entity object and the second entity object in the business register: generating new association information indicative of the association between the first entity object and the second entity object, the new association information including the first entity identifier of the first entity object and a second entity identifier of the second entity object; generating an association write request to write the new association information to the graph data structure; providing the association write request to the graph data structure.

In some embodiments, after providing a response to the target object read request including the first entity object, the method may further include: performing validation that the first entity object corresponds with the target entity object.

Some embodiments relate to a system comprising: one or more processors; and memory comprising computer executable instructions, which when executed by the one or more processors, cause the system to perform the method of any one of the methods described herein.

Some embodiments relate to a computer-readable storage medium storing instructions that, when executed by a computer, cause the computer to perform the method of any one of the methods described herein.

### BRIEF DESCRIPTION OF THE DRAWINGS

Various ones of the appended drawings merely illustrate example embodiments of the present disclosure and cannot be considered as limiting its scope.

FIG. 1 is a schematic illustration of an example graph data structure, according to some embodiments;

FIG. 2 is a block diagram of a graph interface module, according to some embodiments;

FIG. 3 is an example of a data structure in the form of tables, representing part of a graph data structure, according to some embodiments;

FIG. 4 is a block diagram of a system for updating a graph data structure, according to some embodiments;

FIG. 5 is a block diagram of a business register module and a graph interface module of the system of FIG. 4, according to some embodiments;

FIG. 6 is a schematic illustration of a business register data structure representing a subset of the graph data structure of FIG. 1, according to some embodiments;

FIG. 7A is a process flow diagram of a method of reading target data from a first data structure, according to some embodiments;

FIG. 7B is a process flow diagram of a method of reading association data from a second data structure, according to some embodiments;

FIG. 8 is a schematic representation of a first example of reading target data from a first data structure, according to the method of 7A;

FIG. 9 is a schematic representation of a second example of reading target data from a first data structure, according to the method of 7A;

FIG. 10 is a schematic representations of an example of reading association data from a second data structure, according to the method of 7B;

FIG. 11 is a process flow diagram of a method of writing association data to a second data structure, according to some embodiments;

FIG. 12 is a schematic representation of an example of writing association data to a second data structure, according to some embodiments; and

FIG. 13 is a process flow diagram of a method of updating a business register, according to some embodiments.

### DETAILED DESCRIPTION

Embodiments generally relate to methods, systems and computer-readable storage medium or media for updating a graph data structure, such as a knowledge graph, to reflect determined or inferred associations and relationships between data objects in the graph structure. Information of the graph data structure (or a subset of data within the graph structure) may be incrementally updated and/or added to on the basis of user actions or system actions. Some embodiments relate to updating the graph data structure through the use of services and/or products, and/or dynamically updating parts of the graph data structure to improve the provided services and/or products. Some embodiments relate to the use of a feedback loop to update the graph data structure.

The graph data structure (or “graph”) may represent a network of entities (such as people or things), for example entities associated with an accounting platform, and the information and relationships known about those entities. The graph may be an enriched information interface, which may be capable of providing a coherent and/or enhanced view of knowledge about the network of entities. The graph may be initially generated or created based on raw data derived from how the accounting platform is used by organisations to manage their accounting needs. The raw data may be fragmented, inconsistently named, under documented and/or difficult to interpret. The raw data may be data collected and stored in a database. For example, the raw data may be accumulated and stored in a database accessible to an accounting system or platform for managing accounts (such as maintaining bookkeeping accounts) associated with a plurality of businesses or organisations.

In some embodiments, the graph may be updated based on raw data extracted from an external source. The external source may include documents, such as financial documents including invoices or statements, which may have been generated by, or uploaded to, the accounting platform. Alternatively or additionally, the external source may include one or more databases, such as an external database in communication with the accounting platform. The data extracted from the external documents or databases may include data lines from a financial statement which represent individual transactions and their associated details. The raw data may comprise entity information. For example, entity information may comprise information about particular organisations such as financial or banking information, accounting information, type of organization, practice area, number of people employed by the organisation, contacts of the organisation and/or information which is otherwise relevant or related to the organisation. Contacts of the organisation may include people or other entities that do business with the organisation. For example, a contact of a primary organisation may include a separate contact organisation (a Contact) which has made payment to the primary organisation, or to which an invoice has been issued by the primary organisation.

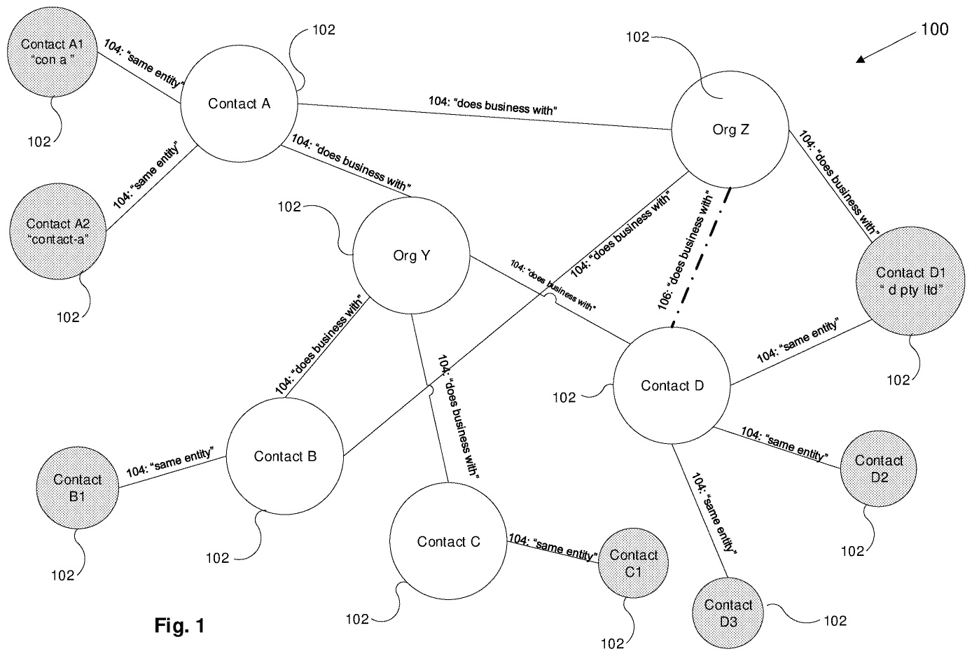

An example of a graph 100 is depicted in FIG. 1. The graph comprises a plurality of nodes or vertices 102, some of which are connected or interconnected with or to other vertice(s) by edge(s) 104. The graph 100 may comprise multiple different types of vertices. For example, vertex types may be organizations, apps, employees, contacts, business types, partners, interactions such as events or transactions, and the like. For example, an interaction may be a financial transaction or an API call to an app. Each vertex 102 may have a plurality of fields, which may be mandatory or optional. Each field may be populated with an attribute or a property of the vertex 102.

The vertice(s) 102 of the graph may be determined or generated from the raw data. One or more vertice(s) 102 may be associated with a respective object of the raw data, for example, that is, representative of a real world entity. Accordingly, vertice(s) may be determined, in that they may be identified or obtained directly from the raw data. Where the vertex 102 is an object, it may be mapped to an object of the raw data. This mapping may be performed by using an object identifier to map the object of the raw data to an object in the graph structure. For example, the raw data object extracted may be a transaction which includes an object identifier in the form of a Business Number (BN). This BN is then used to map the raw data object to an entity vertex representing a Contact, where the entity vertex includes an entity identifier which is the same as the BN. This enables the Contact to be readily identified in the graph structure by using identifying information related to that entity.

In some embodiments, vertice(s) 102 may be inferred or deduced from the raw data, or from objects of the raw data, or from vertices and/or edges of the graph 100 itself. Vertice(s) 102 and edges 104 may be updated or inserted based on inferences or deductions made from the objects of the raw data. In some embodiments, an object type “business type” may be inferred from contact and organisation information of the raw data. In some embodiments, an object type “association type” may be inferred from raw data. For example, it may be inferred that there is a business association (i.e. a particular type of object) between an organisation and a contact based on a transaction line in an organisation's financial statement which contains a name or business number of a contact. In such an example, the vertex 102 representing the organisation may be connected to a vertex 102 representing the contact using an edge 104 “does business with”.

Each edge 104 defines a relationship between two vertices 102. An edge is representative of a fact or state that holds between the two vertices 102. The relationship may be determined from the raw data, or maybe inferred from the raw data based on interactions or transitivity between objects of the raw data, and/or edges 104 and/or vertices 102 in the graph 100. For example, the inferred relationship (or inferred edge) may not be captured in the raw data. The inference may be based, for example, on properties of the two vertices 102 joined or connected by the inferred edge 104 (for example, similarity in name and potentially similarity in other metadata), interactions that have been recorded (in the raw data and/or the graph 100) between the items of information (objects or inferred objects) represented by the specific vertice(s), the nature of interactions in the raw data (such as reconciling financial transactions) or logical deductions.

The relationships between vertices may also be determined or inferred from data extracted from an external or associated data source. New relationships may be generated through inferences and determinations made by extracting or reading data from data sources before being updated in the graph structure. This may include creating new links and associations between vertice(s) in the form of edge tables, or updating the nature of the associations by updating, changing or swapping edge tables, or fields within edge tables. For example, where a contact name of a contact is extracted from a financial statement of a primary organisation, it can be inferred that a relationship exists between the contact and the primary organisation to which payment was made. In this case, a new edge object may be created having a relationship type such as “is associated with”, “does business with” or “made payment to”.

In other embodiments, relationships may be directly determined through the capturing of received input into a system, such as user inputting information into a user interface. The user interface may be in the form of an accounting platform. For example, where a user representing a primary organisation entity adds a new organisation to a “contact list” within an accounting platform, the new organisation is then associated with the primary organisation in the graph structure through the creation of a new edge object defining the relationship.

The graph 100 may comprise multiple different types of relationships and accordingly, the edge(s) of the graph 100 may be associated with different relationship types. For example, a relationship type may be “does business with”, “is the same as”, “same entity”, “works for”, “employs” and the like. The graph 100 may comprise multiple edges 104, for example, of different edge types, between the same two vertices 102. In some embodiments, each edge 104 may be representative of an individual interaction between the entities (objects or inferred objects) of the two vertices 102 interconnected by the edge 104. For example, each edge 104 may be representative of an edge type and a specific interaction. Each edge 104 may have a plurality of fields, which may be mandatory or optional. Each field may be populated with an attribute or a property of the edge 104.

The graph 100 may therefore represent different semantic relationships between types of vertices 102. Referring to the example of FIG. 1, graph 100 comprises vertex 102 “Org Z”, which is connected to vertex 102 “Contact A” by edge 104 “does business with”, demonstrating the relationship between the objects Org Z and Contact A. Similarly, vertex 102 “Contact D” is connected to vertex 102 “Contact D1” by edge 104 “same entity” demonstrating the relationship between objects Contact D and Contact D1. In some embodiments, the graph may represent inferred associations 106 between vertices 102. For example, as shown in FIG. 1, Org Z is connected to vertex Contact D1 by the edge “does business with”. Contact D1 is connected with the vertex “Contact D” by the edge “same entity”. It may therefore be inferred that Org Z may be connected to vertex Contact D by an inferred association 106 “does business with”.

In some embodiments, additional or aggregated information about the vertice(s) 102 and/or edge(s) 104 may be surfaced or stored as metadata annotated on the respective vertex 102 and/or edge 104. For example, where two vertices 102 are interconnected by an edge 104 that is representative of the relationship between the two vertices 102, additional or aggregated information about interactions between the two vertices may be recorded or stored as metadata annotated on the respective edge 104. This may be stored by updating specific fields in the edge tables or vertex tables.

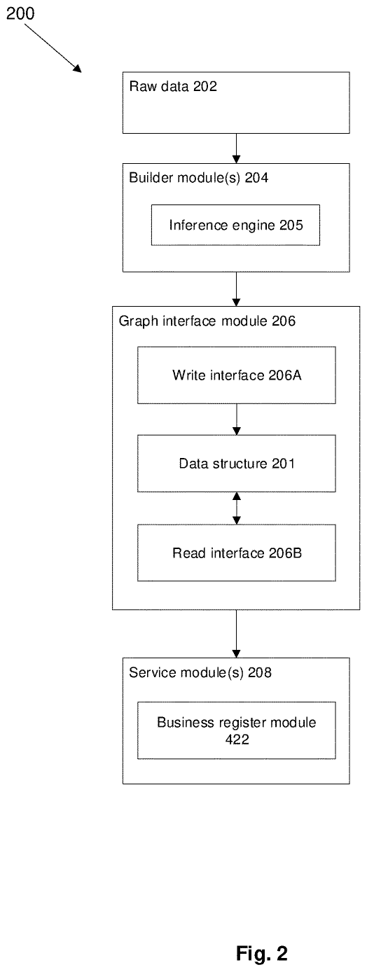

Referring now to FIG. 2, there is shown a high level overview 200 of a system configured to update, append to and/or use a graph data structure, according to some embodiments. The graph 100 may be generated or built according to the process described in PCT/NZ22/50152, the contents of which are incorporated herein by reference. The graph 100 may be generated using one or more builder module(s). The builder module(s) determine the vertice(s) and/or edge(s) of the graph 100 based on corresponding objects and/or object relationships extracted from raw data. The builder module(s) are configured to create, update, insert and/or upsert relevant table(s) of a data structure 201 by cooperating with a graph interface module 206.

The graph interface module 206 comprises a write interface 206A, a data structure 201, and a read interface 206B. The write interface 206A of the graph interface module 206 is configured to map data (edges 104 and vertices 102) to the data structure 201 in response to write requests received from the builder module(s) 204 or from one or more service module(s). Write requests may comprise data including edges and vertices to be written to the data structure. For example, the write interface 206A of the graph interface module may be configured to write new associations or relationships (edges 104) between two vertices 102 by creating a new association object within the data structure 201. The data structure 201 may be configured to represent all or part of the graph 100, or may be a separate database such as a relational database, non-relationship database or tabular data structure.

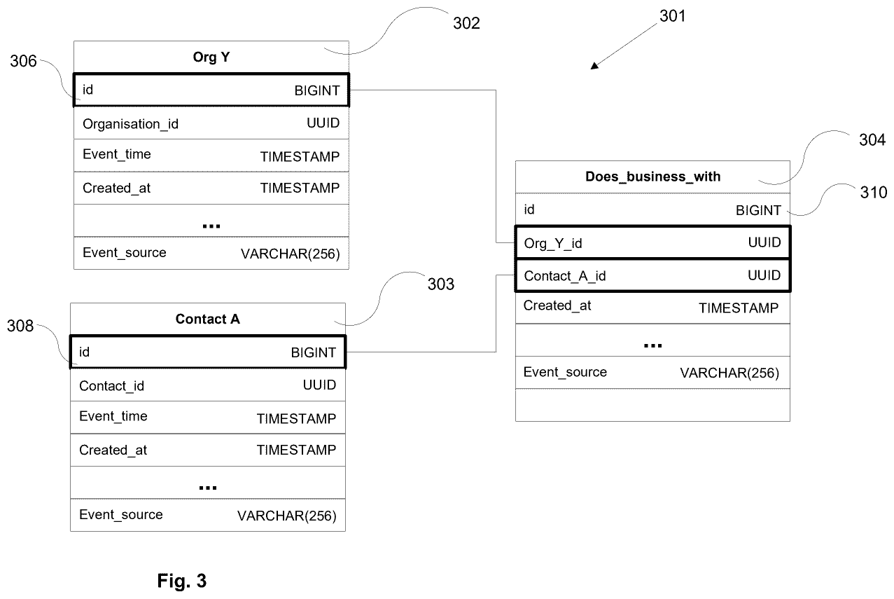

Referring now to FIG. 3, there is illustrated example data 301 from the data structure 201 represented in tables. The example data comprises a plurality of tables 305. The data structure 201 provides flexibility to the graph interface module 206, allowing for new vertice(s) and edge(s) to be incorporated into the data structure without requiring significant schema migrations for every change required, and supporting growth and change in the data structure 201. For example, the ability to insert new associations between objects into the table in the form of edge objects means that the entity objects do not require to be changed themselves. As illustrated, the data structure 201 comprises a table for each respective vertex type and a table for each respective edge type. In the example of FIG. 3, tables are shown for each of vertex “Org Y” 302, vertex “Contact A” 303 and edge “does_business_with”. The vertex tables 302, 303 hold a mapping between an identifier and an entity. For example, each entry in the vertex table “Org Y” has an identifier 306, which may be unique to the vertex table 302 “Org Y”, or all vertex tables in the data structure 201. Similarly, each entry in the vertex table “Contact A” has an identifier 308, which may be unique to the vertex table 302 “Contact A”, or all vertex tables in the data structure 201. The edge table 304 holds a mapping between one or more identifiers and a relationship. For example, each entry in the edge table 304 “does_business_with” includes an identifier 310, and the identifiers 306, 308 of the vertices connected by the edge, in this case, the identifier 306 of the “Org Y” and the identifier of “Contact A” 308 in the vertex tables 302, 303. Linking tables 302 and 303 based on shared identifiers or keys, in other words, performing a JOIN on these tables 302 and 303, allows for a full view of the dataset to be obtained.

The read interface 206B of the graph interface module 206 may be configured to query the data structure 201 in response to received read requests. Further, the read interface 206B may be configured to query an associated data structure, for example, a data structure 506 which is part of a business register module 422. The associated data structure may be part of any related service module(s) 208. Read requests may be received from the service module(s) 208. In some embodiments, read requests may be received from an external source, such as through a communications network 410, via a user device 408, or via a transaction reconciliation module. For example, the read request may be generated by a transaction reconciliation module to query the data structure 506 of the business register module. In other embodiments, the read request may be generated by the graph interface module after receiving input from the builder module(s) 204. Read requests from the read interface 206B query the data structure 506 to return a response to the read request.

The read request may require a partial match to data within the data structure 506, or it may require an exact match. In some embodiments, the response may return one or more objects from the data structure 506. In embodiments where the read request returns no result after searching the data structure 506, no objects may be returned and/or a false value may be returned. In some embodiments, the read request may be sent to one or more service module(s) 208 to query a related data structure of a service module 208.

In some embodiments, validation of the first object in the returned response may be performed. In some embodiments, where a first object is returned from the data structure 506 in the response, a user may be requested to validate and/or confirm that the first object corresponds with the target object. Validating the returned object may include confirming that the first object is a direct match to the target object, or it may include validating that the target object is an alias of the first object. Where the first object is validated to correspond to the target object, the response may then be used to perform additional actions, such as checking and updating the data structure 201. In some embodiments, where the first object is not validated to correspond to the target object, a prompt may be provided to enable a new object or label to be created which corresponds with the target object.

Most read and write operations will only relate to a few node or edge types. For example, a read request may only be required to search objects of type “Contact” within the data structure. Accordingly, by adopting this approach, those read and write operations will only require access to tables with the relevant data. This means that data access is distributed, and read requests and write requests tend not to get bottlenecked. Furthermore, adding new vertex and/or new edge types to update the data structure 201 will not impact existing schemas of tables. Having edges represented by separate tables provides flexibility to have many different types of edge 104 attached to the same vertex 102. In this way, the data structure 201 may be efficiently updated by inserting new tables relating to edges and vertices into the structure, without modifying the existing tables.

Additionally, an all-inclusive generic schema for the objects in the graph 100 needn't be developed to accommodate all types of vertices 102 and/or edges 104. Instead, vertices 102 and edges 104 may have attributes relevant to their type, with clear meanings, rather than generic attributes used in different ways for different types. In some embodiments, the attributes selected for types of vertices and/or edges 104 may be derived with a view to the overall concept, as opposed to, for example, specific use cases for the data.

In some embodiments, as vertices 102 and edges 104 have attributes specific to their type, the schema for each table of the data structure 201 may be different. Each table in the data structure 201 may include one or more mandatory fields. For example, one or more of the following may be included as fields of the table 302: (i) an identifier “ID”, which may be unique within the table 302 for the vertex 102 type; (ii) created time, that is the time at which the table was created; (iii) updated time, that is the time the table was most recently updated; and/or (iv) a builder module identifier, which may have instigated the creation of the table, and/or may have updated the table 302. For example, the builder module identifier may be overwritten or updated as the table is edited or modified. In some embodiments, builder module(s) 204 may be required to populate all mandatory fields of a write request (such as an event data structure) for a vertex and/or edge. In some embodiments, write requests with missing information in mandatory fields may be requested, and/or not mapped to the relevant table of the data structure 201 by the graph interface module 206.

In embodiments where an entity represented by a vertex 102 corresponds to an object of raw data (as distinct from an inferred object), an object identifier, “object ID” (for example, an organisation ID or a contact ID), may be included as a field of the table 302 to link or map the table 302 and the entity represented by the table 302, to the object of the raw data 202, for example, as may be identifiable in a database used by an accounting platform to providing accounting services.

As an edge type may be used to connect different types of vertices 102, edges 104 may need to be able to identify the two vertex types they connect. This may be achieved by including fields in the edge table for both vertex types, such as the table name of the vertex type and vertex ID. For example, a “same entity” edge could connect two “Contact” vertices, two “Org” vertices, or a “Contact” vertex and an “Org” vertex.

In some embodiments, the data structure 201 may be configured to be updated through the write interface 206A of the graph interface module 206. For example, the graph interface module may use an “insert” mode, such that the existing information of the data structure is retained, and new information is inserted between existing information. “Insert” mode requests may be batched and processed by a builder module 204 to the graph interface module 206 at given periods, such as daily. “Insert” mode may provide the benefit of traceability, with every interaction being recorded. This would provide options for auditability and traceability. This may also allow for an option to view the data structure 201 at a particular point in time.

The builder module(s) 204 may be capable of triggering random or ad hoc access updates. For example, the write interface 206A of the graph interface module 206 may be configured to update the data structure 201 based on a response to a read request. There may be situations where multiple builder modules 204 are attempting to create and/or update or are creating and/or updating the same edge or node types. As an example, there might be multiple builder module(s) 204 each running processes that need to add to the graph 100 “Organisation” nodes that might not yet exist. These situations may be accommodated for by the builder modules 204 cooperating with a write interface 206A of a graph interface module 206 of the system, as opposed to allowing direct access, or writes, to a data store or data structure, such as a relational data store that underpins the graph data structure, or by which the graph data structure is represented.

The graph interface module 206 is configured to communicate or cooperate with one or more service modules 208 to provide services, views and/or products, for example to organisations or users of the accounting platform 404. The service module(s) 208 are configured to provide service or views based on or built on information derived from the graph 100. The read interface 206B of the graph interface module 206 may be configured to receive and process read requests received from the service module(s) 208, or external modules, and to provide the required information. In some embodiments, the write interface 206A of the graph interface module is configured to receive and process write requests received from the service modules(s) 208 and to write the information to the service module(s).

The service module(s) 208 may be configured to provide views or services as a standalone service or view, or as part of a greater product. In some embodiments, the service module(s) 208 may be the graph interface module. An example of a product provided by a service module(s) 208 is a business register 150.

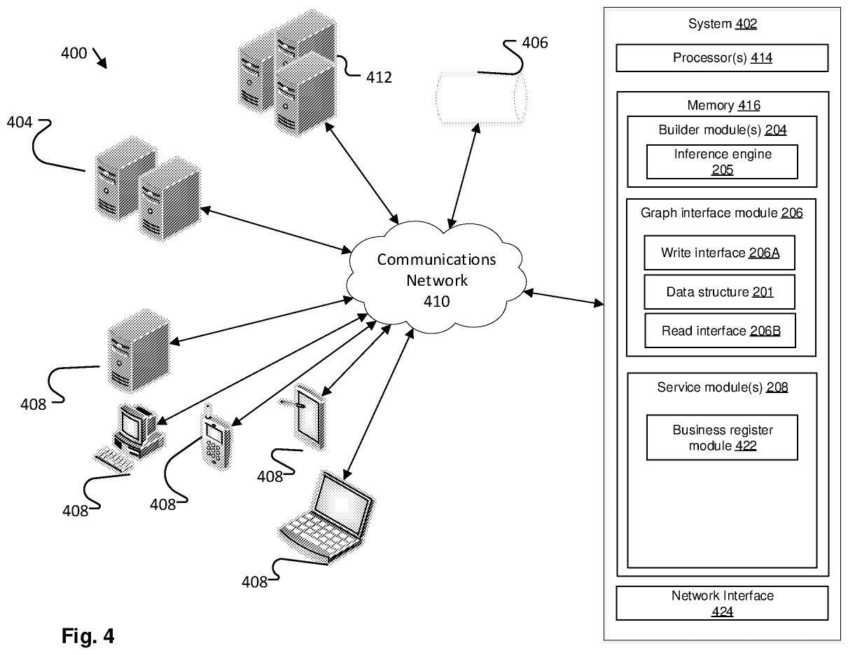

The graph interface module 206 and a service module 208 may form part of a system 402, as shown in in FIG. 4. The system 402 comprises one or more processors 414 and memory 416. The processor(s) 414 may include an integrated electronic circuit that performs the calculations such as a microprocessor or graphic processing unit, for example. Memory 416 may comprise both volatile and non-volatile memory for storing executable program code, or data. Memory 416 comprises program code (for example modules or engines) which when executed by the processor 414, provides the various computational capabilities and functionality of the system 402. Memory 416 comprises the one or more builder modules 204, the graph interface module 206 and one or more service module(s) 208. The builder module(s) 204 are configured to determine connections or relationships between entities in raw data 202 to enable updating of a graph 100 through the graph interface module and the one or more service module(s) 208.

In some embodiments, the system 402 may be implemented as a distributed system comprising multiple server systems configured to communicate over a network to provide the functionality of the system 402. For example, one or more of the program code (for example modules or engines) may be deployed on one or more disparate or remote servers, which may cooperate to provide the functionality of the system 402 described.

In some embodiments, there may be multiple service modules 208 using the same vertices 102 and/or edges 104 at the same time for providing or supporting services and/or products. That is, one or more service modules may interact with all or some of the objects in the graph 100 or the data structure 201. In some embodiments, the service module(s) 208 may request data from the read interface 206B of the graph interface module 206 in batches, although single record queries may be accommodated. An example request may be to provide to the service module 208 “all X's that have Y connection to Zs”. For example, the request “all Contacts that have “does business with” connections to “Organisations”, may be used to form a business register 150 that provides a list of all entities which are contacts of any organisations using an accounting platform.

In some embodiments, the service module(s) 208 may comprise a business register module 422. For example, the business register module 422 may be configured to generate and maintain a business register based on vertices 102 of the graph 100 representing contacts and connected by “same entity” edges 104 as acquired from the graph interface module 206. For example, a list of all contacts (representing businesses), and their aliases including different names and/or formatting which represent the same contact. The business register module may contain a defined subset of the vertice(s) and/or edge(s) of the graph 100.

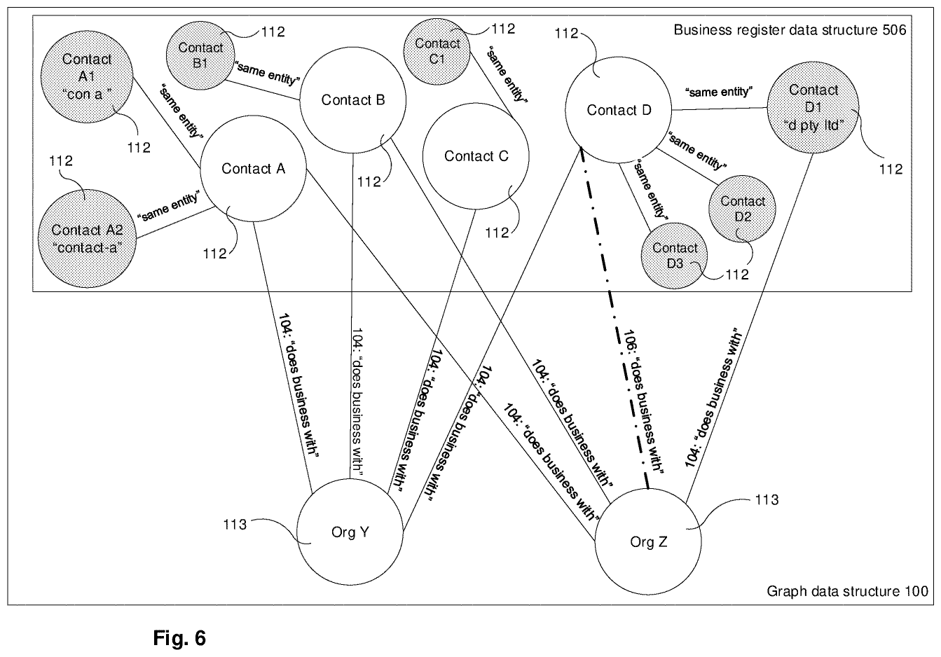

The business register module may include a plurality of vertices 102 which represent data about contact entities. FIG. 6 provides a schematic illustration of an example business register data structure 506, which is formed from a subset of contact vertice(s) 102 of the graph 100. The business register data structure 506 may include edges which represent data about associations between contact entities and another predefined object type. For example, the business register may include edges representative of associations between two contact objects, such as a “same entity” edge. In another example, the business register may include edges representative of associations between a contact object 112 and an organisation objects 113, such as a “does business with” edge. In other embodiments, the business register module may be configured to communicate with the graph interface module 206 to access edge tables in the overarching graph 100 connected with vertice(s) 102 in the business register 150. In some embodiments, the business register data structure 506 is a relational database, non-relationship database or tabular data structure. The business register data structure 506 may be configured to store information from the data structure 201 which relates to contact type vertices and arrange the information such that the data structure 506 provides a list of contacts and their related aliases. The data structure 506 may include a one or more canonical objects, each having an associated set of aliases. In some embodiments, the data structure 506 which is a business register 150 comprises at least one canonical first object and a set of aliases (or alias objects) associated with the at least one first object. For example, the canonical first object may include an entity name “Contact A Pty Ltd”. The set of aliases associated with the canonical first object may include variations of the entity name, for example, “Contact A”, “contact a pty ltd”, “contact-a”, “Con-A”, “CA Pty Ltd” and the like. The set of aliases are variations in value of the entity name, which may differ by character class, case, value or the like. The ability for alias objects to be associated with a canonical first object means that variations in formatting or extracted strings pulled from an external data source, such as a financial statement, still enable the extracted string value to be matched to an alias and/or a canonical first object within a business register, regardless of format and differences. Fuzzy matching techniques may be used to improve matching of extracted strings to the canonical first objects or their associated aliases.

The mapping of alias objects to canonical first objects within the data structure 201 enables the information to be represented in a plurality of different configurations. For example, it may allow for flexibility with how the data structure 506 or the business register 150 can be displayed and/or configured. The mapping of alias objects with canonical first objects may also enable normalisation and/or aggregation of corresponding data, create cohesion between data objects and/or be useful for making recommendations or determining corresponding matches within the data structure 506 in response to a request for information with greater accuracy.

Additionally, the structure of the data may be beneficial in helping to disambiguate specific subsets of data for the purposes of reducing noise within the data structure 201 and more accurately responding to a query of the data structure 201 or data structure 506. For example, the data structures 201 or 506 can be arranged such that all aliases for “Company A” return the “Company A” entity object. In other cases, where “Company A” has a plurality of franchises across different suburbs, it is possible to link and/or arrange subsets of nodes within the data structure 201 to enable more accurate object identifications for each franchise of “Company A”. That is, it is possible to distinguish between “Company A Franchise #1”, and “Company A Franchise #2”. As links between data objects can be maintained regardless of the display and/or abstraction of the objects within a particular service module, this may allow for greater flexibility in how the data can be used, updated, appended, viewed and/or structured. For example, by separating the data structure 506 and the data structure 201, different views and/or abstractions can be provided to serve different applications.

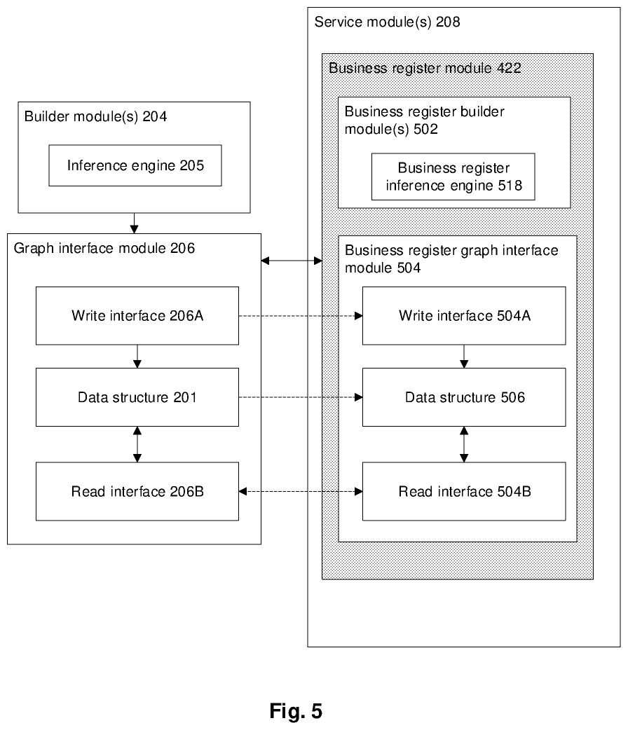

FIG. 5 is a block diagram of the business register module and the graph interface module of FIG. 2. The business register module 422 may comprise a business register interface module 504. The business register interface module 504 may comprise a write interface 504A, a data structure 506 and a read interface 504B. The business register interface module 504 may be functionally similar to the graph interface module 206. In some embodiments, however, the business register interface module 504 may be replaced with a business register database (not shown), such as a relational database or a tabular data structure. The business register module 422 may include builder module(s) 502. The business register builder module(s) 502 may be configured to perform in a similar manner to the builder module(s) 204 to use raw data to generate write requests for a business register interface module 504 of the business register module 422 to update or add to the data structure 506.

In some embodiments, the graph interface module 206 is in communication with the business register module 422. The graph interface module 206 is configured to directly communicate with the business register interface module. For example, the write interface 206A may communicate with the write interface 504A of the business register interface module 504 to update data structure 506. In some embodiments, the write interface 206A of the graph interface module 206 may be configured to communicate directly with the write interface 504A of the business register interface module 504 in order to update the data structure 506. The data structure 506 may include all or part of the data objects in the data structure 201. As such, updating of data structure 506 simultaneously updates the data structure 201.

Read interface 504B is able to query the data structure 506. However, read interface 504B may also transmit read requests through the read interface 206B of the graph interface module 206 to query the data structure 201. In some embodiments, the graph interface module may be configured to directly query or write to the data structure 506. In some embodiments, a read request may be received by the read interface 504B to query the data structure 506. In some embodiments, the read request may be received from a transaction reconciliation module. In other embodiments, the read request may be generated by the graph interface module and provided to the read interface 504B. Alternatively, the read interface 206B of the graph interface module may directly query the data structure 506. Read requests from the read interfaces 206B and/or 504B query the data structure 506 to return a response to the read request.

In further embodiments, the graph interface module 206 may comprise the business register interface module 504. In other embodiments, the business register interface module 504 may be the graph interface module 206.

The processor(s) 414 of system 402 may execute computer instructions stored in memory 416 to enable the graph interface module 206 to write data to the business register data structure 506 (for example, using the write interface 504A) and/or read data from the business register data structure 506 (for example, using the read interface 504B).

In some embodiments, the data structure 506 represents a subset of information from the data structure 201. When the write interface 504A writes new information to the data structure 506, this is reflected in the data structure 201. In some embodiments, the write interface 504A writes new information directly to the data structure 201, or may send a write request to the write interface 206A for writing to the data structure 201. Further, as data structure 506 represents information from data structure 201, updates in the data structure 201 may be reflected in the data structure 506 once they are made. For example, if a contact object was added to the data structure 201, and the business register data structure 506 was configured to hold a subset of information including all contact objects in the data structure 201, then the business register interface module would reflect the new contact object in data structure 506. In other embodiments, information within data structure 506 may be manually updated based on a request or instructions from a user.

The business register module 422 may be configured to receive a request for organisation or contact details from a user, such as a user of the accounting platform 404 associated with a particular organization. In some embodiments, the read request may be received from an external module, such as a transaction reconciliation module. The business register module may further be configured to maintain an extended business register that additionally stores vertices connected by “does business with” edges as acquired from the graph interface module. That is, in some embodiments, the business register may store all entity type vertice(s), for example, contact type vertice(s) and organisation type vertice(s). The business register module 422 may be configured to send a read request to the read interface 206B of the graph interface module 206, the read request identifying an organisation or contact as a vertex, and an associated relationship as an edge identifier (for example, “is associated with”, “is the same as”, “does business with”, “works at”, “works for” etc.). The business register module 422 may be configured to receive a read response from the read interface 206B, the read response comprising one or more vertices recorded in the graph 100 as being connected to the provided vertex with the indicated edge type.

The business register module may be dynamically updated by reflecting new vertice(s) and edge(s) which are recorded or created in the graph 100. In some embodiments, these updates may be undertaken on the basis of raw data extracted from an external data source, or through actions taken by the user such as adding a new business contact to their account. For example, updates may be a result of data processed by a transaction reconciliation module. As the business register module is configured to maintain a business register based on the vertices 102 of graph 100 acquired by the graph interface module, it can be updated in real time to reflect updates to the graph structure. For example, when a new contact is added by a user of an accounting platform, the contact may be written to the graph structure as a contact vertex. In one example, the business register 150 may maintain a register of businesses which are defined as object type “Contact”. When the graph 100 is updated with the new contact vertex, the business register module 422 extracts the updated information when it sends a request to the graph interface module for the data structure 506, and the new contact vertex is reflected in the response to the request to return all contact vertice(s).

The business register module may be dynamically updated using a feedback mechanism or a feedback loop. The feedback loop may be a function enabled by the business register graph interface module, and configured to read and write based on feedback received from inputs, actions or information received by the business register module. In some embodiments, feedback from reconciliations may be utilised in order to update and/or augment the graph structure. For example, using interactions, such as those performed by an end user, along with predictions and/or suggestions made, enables any updates to be validated and the coverage and precision of the graph structure to be improved. Utilising feedback from end-user interactions provides a mechanism that enables simultaneous and/or immediate augmentation of the graph structure by writing new vertices and/or edges to the graph structure, or to data from ancillary systems which may be used by the business register module.

The business register module may be configured to predict new contact in situations where there does not yet exist an association between the organisation and the contact. In some embodiments, the feedback loop may be used when a user accepts one of these predictions, and the prediction of the contact and/or association is accepted and/or validated in order to be written into the system. However, the feedback loop my be configured such that, if a user accepts the prediction, that a “new” contact is not continually predicted and written to the graph data structure to create multiple entries. Rather, the feedback loop may utilise a feedback identifier attached to the contact object or the validation edge each time it is predicted after if has been accepted as a contact and/or written to the graph structure. In some embodiments, the data required to provide the feedback to the graph structure includes at least an organisation, a predicted contact, and a reconciliation event to a contact object (that is, whether it matches the prediction or not).

In some embodiments, the feedback loop may be configured to determine whether a reconciliation is in error, for example, where a suggested prediction for a contact becomes associated with an unrelated contact vertex. In such a case, the reconciliation may be determined to be in error automatically by a recognition and/or evaluation algorithm, or it may be identified and updated manually. Errors caused by the feedback loop may be identified in real-time, for example, by performing an additional validation step to determine the accuracy of the reconciliation. In some embodiments, errors caused by the feedback loop may be manually updated and/or corrected, for example, by implementing a batch update to remediate any association errors which have been identified in the data structure. In some embodiments, end-user feedback provided by the feedback loop may update a subset of the graph structure, for example, relating to the user's own contacts, but may not propagate immediately through to update the data structure of the business register module that may be accessible by other users.

The feedback loop may also be configured to update entity details for, or related to, a contact object. If an organisation updates any facets of its details, a new contact object may be created. For example, an organisation which has rebranded and/or changed its name may require a new contact object (or contact identifier). In this case, the data received from the feedback loop may be used to identify that the contacts objects are linked. The data received may also inform a manual process for review, for example, by flagging that a number of similar reconciliations have occurred over a predetermined time period. In some embodiments, the data received may include reconciliation data, prediction data, contact label data, and/or query extraction data. For example, the data received may be used to write a new edge to the data structure that species a “previously identified as”, “also known as” or “now known as” association between vertices representing the old and new contact objects. In some embodiments, vertices associated with the old contact object may be updated to refer to the new contact object. This referral may be based on hierarchies which exist between the vertices based on the defined association. For example, the edge “now known as” between two vertices may create a higher priority for the new contact object. In some embodiments, associations may be rewritten to create edges between previously related vertices and the new contact object. The old contact object may then be decommissioned, archived, and/or assigned a lower weight in relation to the new contact object.

The feedback loop may be configured to refresh alias objects within the business register module. For example, this may depend upon data received from user input, such as what they have labelled or named their contacts. In some embodiments, the feedback loop may be configured to feed the received aliases back into the graph data structure for use with predictions and/or suggestions. In some embodiments, where aliases are used by a number of users (for example, the alias has increased in popularity), then the alias may be written automatically into the graph structure. Alternatively, or additionally, a manual review process may be used before writing the alias to the graph structure and using it to form the basis of predictions and/or suggestions. In some embodiments, the business register module may return an entity object, or a vertex related to a specific entity, which has a specific granularity specified by type. In some embodiments, the associations between contact objects which represent specific granularities or business details may be used to update the aliases and/or form predictions for related entities. An edge between a contact object and an identifier for an entity may be added to distinguish between aliases and/or specific granularities of entity details provided by the contact object. In some embodiments, a “is called” association between a contact object and an entity object may be written only as a result of the feedback loop provided by the business register module.

The business register module may extract a subset of objects from the graph structure to enable more efficient search and query response times for requests sent to the graph interface module. For example, a candidate entity attribute may be extracted from raw data. For example, a string representing a potential contact name. In cases where the candidate entity attribute is a candidate contact name extracted from a piece of raw data, such as a data line on a financial statement, the business register data structure 506 may be queried to determine a match for the candidate contact name in order to take further actions, such as making a recommendation for a contact name. Querying the business register data structure 506 for the candidate contact name, rather than the entire graph structure inclusive of all objects, means that a subset of relevant objects in the graph data structure are searched in the first instance. For example, a business register data structure 506 may be configured to maintain a list of all contact objects from data structure, or graph 100. By querying the business register data structure, only objects with type “contact” will be searched to determine a match to the candidate contact name. Additionally, the business register data structure 506 may be configured to store aliases relating to contacts, such as other names and/or name formats by which they may be known. This enables related contact names to be searched to determine the actual contact intended by the read request. Once a match is determined, additional queries and requests can be made to the graph 100 based on the one or more identified object in the business register data structure 506. Alternatively, if no object is found or identified, it can be determined that there is no contact object(s) matching the candidate contact name, and therefore that the contact does not exist within the business register data structure 506. From there, a request can either be made to write a new contact object to the graph structure, or to expand search parameters for additional queries.

One or more vertice(s) in the graph 100 may be designated with the type “Contact”. A contact 116 is an entity object 117 represented by a vertex 102 that contains information relating to a contact entity. The information may include a unique business identifier, a standardised name, and/or registered business details about the contact such as ABN or business address. The contact 116 may also include information relating to the specific contact vertex object as it exists within the graph 100 such as the last time the information in the vertex table was updated. The contact object 112 populates and stores the associated contact information in one or more fields or attributes. In some embodiments, the business register module is configured to provide a data structure 506 which contains one or more contact objects from the graph 100. Data structure 506 may contain all contact objects from the graph 100. In some embodiments, the business register module may also provide edges 104 which are linked to the contact objects, where edge(s) 104 may be stored within the business register data structure 506.

One or more vertice(s) in the graph 100 may be designated with the type “Organisation”. An organisation (or “org”) 118 is an entity object 119 represented by a vertex 102 that contains information relating to an organisation entity. The information may include unique organisation identifiers, names, and details about the organisation such as ABN or business address. The organisation object 113 may also include information relating to the org vertex as it exists within the graph 100, such as the last time the organisation entity information in the vertex table was updated. The organisation vertex populates and stores the associated organisation information in one or more fields or attributes. In some embodiments, organisation vertice(s) may be stored within the business register data structure 506. In some embodiments, organisation vertice(s) may be stored outside the business register data structure 506, and may be linked through edges 104 with contact vertice(s) in the business register data structure 506.

One or more edge(s) in the graph 100 may provide association information between two objects. For example, an edge may define an association, relationship or link between a contact object 112 and an org object 113. The association information may include a first object identifier of the first object and a second object identifier of the second object. The first object identifier and/or the second object identifier may be an entity identifier. The association information may further include an association type. Each edge may be designated with an association type that defines the nature of the relationship between two or more objects in the graph structure. For example, an association type between a contact object and an org object may be “does business with”. In another example an association type between a first contact object and a second contact object may be “same entity”.

The graph interface module 206 may be configured to dynamically update the data structure 201 based on extracted raw data. In some embodiments, the data structure 201 may be updated in response to an identified or inferred deficiency or gap within the graph structure 201. For example, where an association is inferred or determined to exist between two objects in the graph structure, but an association read request returns a response that indicates that no association exists, the data structure 201 may be automatically updated to write the determined association between the two objects.

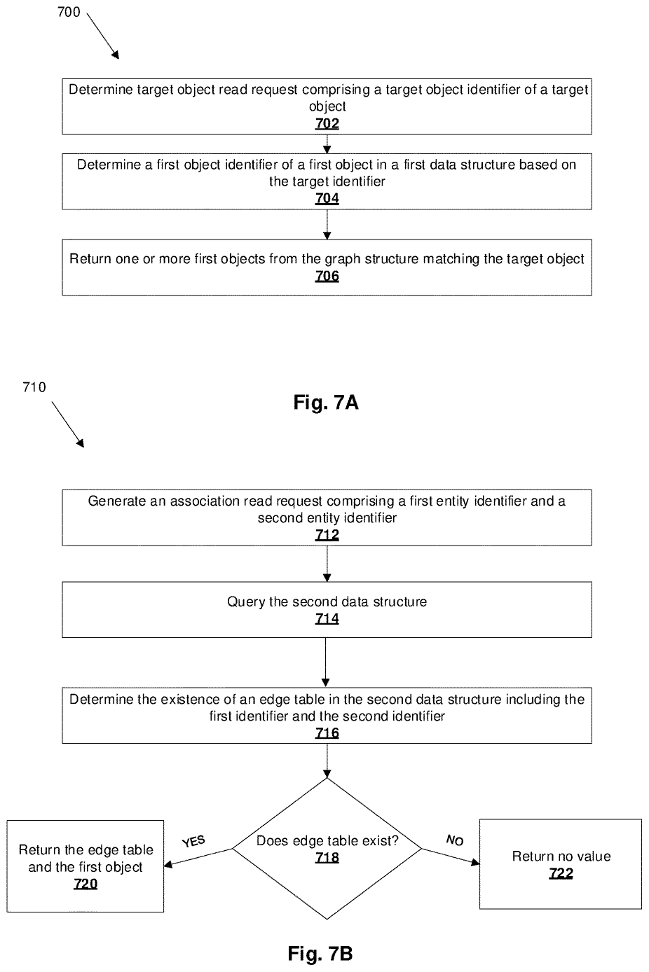

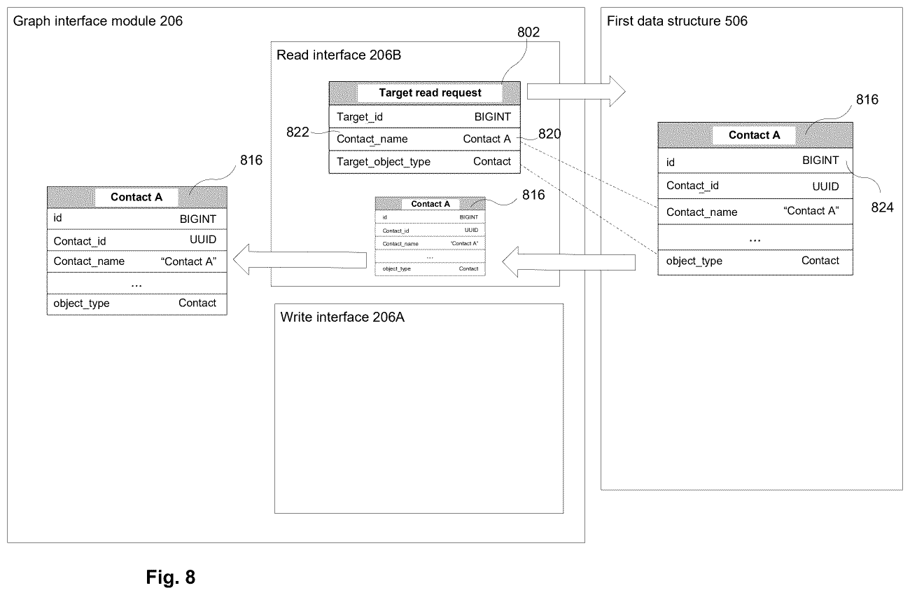

FIG. 7A is a process flow diagram of a method 700 of reading target object information from a first data structure 506, according to some embodiments. The method 700 may be implemented by the processor(s) 414 of the system 402 executing code stored in memory 416. FIG. 8 provides an example representation of the method of FIG. 7A.

In 702, a target object read request 802 for querying the first data structure 506 about a target object 804 is determined. The read request may be received from an external source, such as a transaction reconciliation module, and determining the target object read request 802 may include receiving the target object read request 802 from a transaction reconciliation module. The target object 804 may represent one or more objects 814 of the first data structure 506, such as an entity object, for example a contact object. Alternatively, the target object 804 may include part of an object, such as an attribute 806 or a type 808 of an object. The target object read request 802 includes a target identifier 810 of a target object 804. The target identifier 810 may include an attribute 806 or field, such as an entry within an object type. For example, the target identifier 810 may include a unique identifying value 812 to be matched to one or more objects 814 in the first data structure 506. The target object identifier may be extracted from an external data source and/or raw data. For example, the target identifier may be a string value representing a potential contact name. The string value may be extracted from a financial statement. In some embodiments, the target object read request 802 may include a plurality of target object identifiers 810. In some embodiments, the target object 804 may be determined based on a request from a user via a user interface. The user interface may be a user interface provided by an accounting platform.

At 704, a first object identifier 824 of a first entity object 816 is determined within the first data structure 506 based on the target object identifier 810. The target object read request 802 matches the target object identifier 810 to one or more attribute(s) of a first entity object 816 in the first data structure 506. In some embodiments, the step of determining the target object identifier may include comparing the target identifier with canonical objects stored in the data structure 506. It may further include comparing the target identifier with the sets of aliases which are associated with each canonical object in the data structure 506. Once the read interface 206B identifies a match between the target object identifier 810 and a first object 816, it determines the first object identifier 824 of the first object 816, and at 706 returns the first entity object 816 in response to the target object read request. The response to the target object read request may include sending the response to a transaction reconciliation module to allow the transaction reconciliation module to reconcile a transaction using the first object 816.

In some embodiments, the response to the read request 802 may return one or more entity object(s). Each entity object 816 will have a unique object identifier 824. For example, in cases where multiple entity objects include an attribute 806 that matches the target object identifier 810, all or some of the entity object(s) may be returned. The response to the target read request 802 may include one or more entity object(s). In some embodiments, the entity object(s) which are returned in the response to the target object read request 802 may be filtered based on hierarchical values, additional attributes, associated edges and/or primary designations, before being returned to the graph interface module.

In one example shown in FIG. 8, the target object 804 may be a contact object 816 corresponding to a candidate object name 818 identified from raw data 202. The candidate contact name 818 may be extracted from a data line in a financial statement for the purpose of reconciling a financial transaction. In some embodiments, this step may be completed by a transaction reconciliation module. The target object identifier 810 is then determined to be the attribute “contact_name” 822 having a value of string “Contact A” 820, representing the candidate contact name 818 to be matched to a contact object 816 in the first data structure 506. The first data structure is then queried for contact objects which include an attribute 806 or entry that matches the string “Contact A” 820. Once a contact object 816 having a string value “Contact A” 820 for attribute “contact_name” 822 is identified, the contact object 816 is returned. In the example shown in FIG. 8, the attribute 806 “object_type” with a value of Contact has also been matched to the target read request.

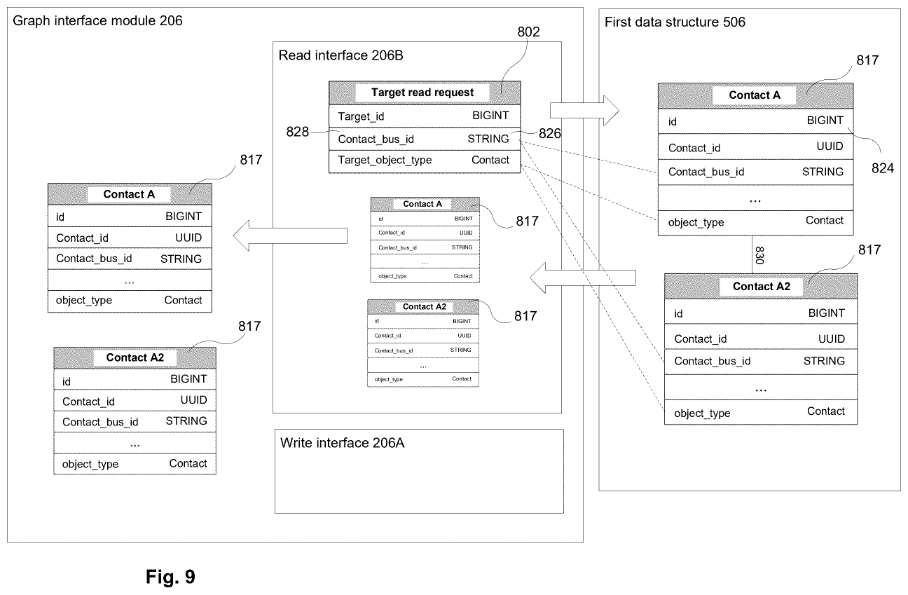

In another example shown in FIG. 9, the target object identifier may be a candidate contact business number 819, which has string value 826, and is matched with the attribute “contact_bus_id” 828. When the first data structure 506 is queried for contact objects having value 826 for attribute 828, a plurality of associated contact objects 817 are returned. For example, there may be a number of contact objects which exist in the first data structure 506 for the same entity that all include the value 826 for attribute 828, but which contain variations in the object tables. For example, the objects may contain different variations in their contact name entries. The contact objects 817 may be associated with each other by an association object 830, which is an edge table with the type “same entity”. In further embodiments, the value 826 may be associated with a primary contact name. The primary contact name may have a plurality of aliases with which it is associated in the data structure 506. In this case, the read request may return the primary contact name along with its associated aliases. In some embodiments, where the read request includes a target object identifier including value 826 and a second value 827 including a contact name, and the second value matches on of the associated aliases, the primary contact name is returned in response to the read request.

In some embodiments, the response may be configured to prioritise the return of a specific contact object of the multiple contact objects 817 based upon a defined hierarchical structure assigned to the contact objects. For example, a contact object may be designated as the primary contact object of the group of contact objects to which all others are related. This may be by determining the number of “same entity” associations the contact object has. Alternatively or additionally, this may be manually assigned. In another embodiment, the defined hierarchical structure may be determined on the basis of a specific attribute which exists within the contact object. For example, a contact object may include a value for attribute “primary”. In other embodiments, the contact object may include a value assigning a hierarchical value or representing a primary or secondary designation. In further embodiments, associated contact aliases are included as attributes within the contact object. In some embodiments, contact objects may be associated by the “same entity” edge to contact variation objects. In this case, where the target object read request returns a contact variation object (an alias), and there exists an associated contact object associated by the “same entity” edge, the response may return only the associated contact object which it determines to be the primary contact object.

In some embodiments, where there is no first object identifier 824 in the first data structure 506 that is associated with or matches the target identifier, a fuzzy matching technique may be employed to determine an object identifier substantially similar to the target identifier. For example, the method may utilise fuzzy matching and/or comparison techniques such as those outlined in PCT/NZ2021/050151, the contents of which are incorporated herein by reference. In some embodiments, fuzzy matching techniques, such as the Python fuzzy matching library rapidfuzz, are used to perform matching of the target identifier and an object identifier. Fuzzy matching computes a similarity score between strings. Fuzzy matching may be based on Levenshtein distance.

In some embodiments, fuzzy matching techniques are used determine a similarity score between the target identifier and an object identifier in a first data structure 506, and identify the object identifier as being associated with the target identifier when the similarity score is above a threshold value. The similarity score may be indicative of a count of how many characters would need to be changed in order for the strings to match, adjusted to account for the length of the strings. By using fuzzy matching techniques, it is not only exact matches that are identified; inexact or similar matches are also determined. This can be useful in particular where exact replications of the first label don't appear in the financial record, or character string. For example, a first label for a financial record may be “Contact A Pty Ltd”, but the character string may only contain the substring “Contact A”. By using a relatively high threshold value for considering candidate substrings as matching, only confident fuzzy matches are determined as matches.

In some embodiments, validation of the first object returned in the response may be performed to determine whether the first object corresponds with the target object. Performing the validation may comprise receiving a validation response, the validation response confirming that the first object corresponds with the target object. After receiving a validation response, the validation response may be sent to the business register module 422. In some embodiments, the validation response may be sent to the graph interface module and/or the transaction reconciliation module. In response to receiving the validation response, association information between the first object and the second object may be determined.

A user may be prompted to validate whether the first object returned in the response corresponds with the target object before any additional actions are performed. If the first object is validated to correspond with the target object, the first object may then be used to determine association information and/or update the data structure 201. The association information, and/or link may only be written to the data structure if validation that the returned first object corresponds with the target object occurs, for example, validation by the user. If the first object is not validated as corresponding with the target object, for example, by the user, then new association information may not be added to the data structure 201, and further actions or processing may be terminated at this point. In some embodiments, where the first object is not validated to correspond with the target object, a prompt may be provided to input a new object, intended object and/or new label for the target object. In some embodiments, where no validation is received, no action is taken to check association information or link the first object to a second object, and/or to update the second data structure 201. In some embodiments, the validation may be performed based on user input, such as a user confirming that the first object corresponds with the target object. Validation may also be performed automatically, for example, by assigning a correspondence probability value and determining whether the probability value is above a predefined threshold.

In some embodiments, the validation is used to provide feedback to the graph data structure, which can then be fed back in subsequent queries. That is, the validation enables a feedback loop which takes the user inputs to feed back received data into the graph structure. This may be referred to as a validation event. In some embodiments, the validation is provided as feedback where the user accepts the suggestion exactly as it is proposed. In other embodiments, the validation is provided as feedback where the user makes changes to the proposed suggestion that are within a predetermined threshold, for example, based on a changed character count or a specific vector distance. In further embodiments, a non-validation may be provided as feedback where the user does no accept the suggestion and instead creates an entirely new contact, or selects an alternative existing contact. Edges and/or associations written to the graph structure as a result of a successful or non-successful validation event may define a specific type of edge, or may include an additional identifier that the edge was formed from a validation event. This enables validation/reconciliation edges to be distinguished from edges and counts informed by document or data extraction events, or inferred events. non-successful validation events may be written as edges that define a non-match, and may provide evidence and/or feedback as to the level of accuracy of the prediction.

In some embodiments, the validation edges may be stored in an alternative data store, and imported or extracted into the graph structure of the business register module once they meet a predetermined count or other criteria. This enables the graph structure to remain clean and simplified without the need to filter out associations which are irrelevant and/or may not be conducive to formulating predictions and/or increasing successful validations. In some embodiments, validation edges are written to the graph only when there is a high probability of match, for example in automated validation of entities. In some embodiments, validation edges are written to the graph only when the user accepts the suggested contact name exactly as it is presented. By writing the new edges between the contact and organisation objects based on user actions, it ensures that the associations are picked up by future versions of the graph data structure used in the business register module and fed back into future business register responses such as predictions and read queries.

FIG. 7B is a process flow diagram of a method 710 of determining association information between a first object and a second object from a data structure, according to some embodiments. The method 710 may be implemented by the processor(s) 414 of the system 402 executing code stored in memory 416.

Once the first entity object 816 is returned at 708, association information between the first object and a second object is ascertained. This information may be inferred by a transaction reconciliation module or other external module, and provided to the graph interface module. For example, an inference engine may determine that, since the transaction reconciliation module is trying to search for a Contact to reconcile a line in a financial statement belonging to an organisation, there exists a contact association of “does_business_with” between the Contact and the Organisation. It is then determined whether an association 838 or link matching the determined association between the first entity object 816 and a second entity object 840 exists within a second data structure 201. The second entity object 840 may be an organisation entity 842. The organisation entity 842 may be determined from raw data, such as the raw data 202 from which the target object 804 was identified. The second entity object 840 may be related to a user or account making the target object read request 802. For example, the second entity object 840 may be an organisation entity, where the organisation entity is associated with a user account, or is identifiable from the raw data, such as being the receiver of a financial statement, or the issuer of an invoice.

Association information 850 between the first entity object 816 and second entity object 840 may be determined by checking whether an association object 852 between the first object 816 and the second object 840 exists within the second data structure 201. The association object 852 may be in the form of an edge 104 table. In method 710, at 712, the graph interface module 206 generates an association read request 856. In some embodiments, the association read request may be generated by an external module, and the graph interface module is configured to receive the association read request 856. The association read request 856 includes target association information 858 between the first object 816 and the second object 840. The target association information 858 may include a first identifier 824 of the first object 816 and a second identifier 860 of a second object 840. The target association information may include the type of association, for example “does business with”, “is a contact of”, “same entity” and the like. In some embodiments, the target association includes a target association identifier indicating the association type. For example, the target association identifier may be a contact association object type. At 714, the association read request 856 is then sent to the read interface 206B of the graph interface module to query the second data structure 201 and determine whether association information 858 between the first object 816 and the second object 840 exists within the second data structure 201.

At 716, the read interface 206B searches edge tables in the structure 201 to identify one or more edge tables in the second data structure 201 that include the target association information 858 in the association read request 856. When the association read request 856 is sent to the read interface 206B of the graph interface module, the read interface 206B queries the graph structure 201 for association object(s) 852 in the form of edge tables which contain both the first identifier 824 and the second identifier 860. In some embodiments, the read interface 206B reads all edge tables associated with first object 816 (that is, containing at least the first identifier 824) to determine whether there is any edge table from that set of edge tables that also contains the second object identifier 860. In other embodiments, the read interface 206B checks the edge tables associated with the second object 840 to determine whether there is an edge table containing the first and second object identifiers 824, 860.

At 718, responsive to one or more edge tables being identified within the structure 201 that include the target association information 858, the graph interface module 206 determines association information 850. That is, it is determined that an association 838 between the first and second objects 816, 840 exists within the second data structure 201. At 720, the read interface 206B may return the first object 816 and/or the association object 852 in response to determining that an association 838 exists.

At 718, responsive to no edge tables being identified within the second structure 201 that include the target association information 858, the graph interface module 206 determines that no association information 850 exists between the first and second objects 816, 840 in the second data structure 201. At 722, no value is returned. In some embodiments, a zero value may be returned when it is determined that no association information exists between two objects in the data structure 201. The existence of no edge table linking the first and second objects 816, 840 indicates that no association 838 exists between the two objects.

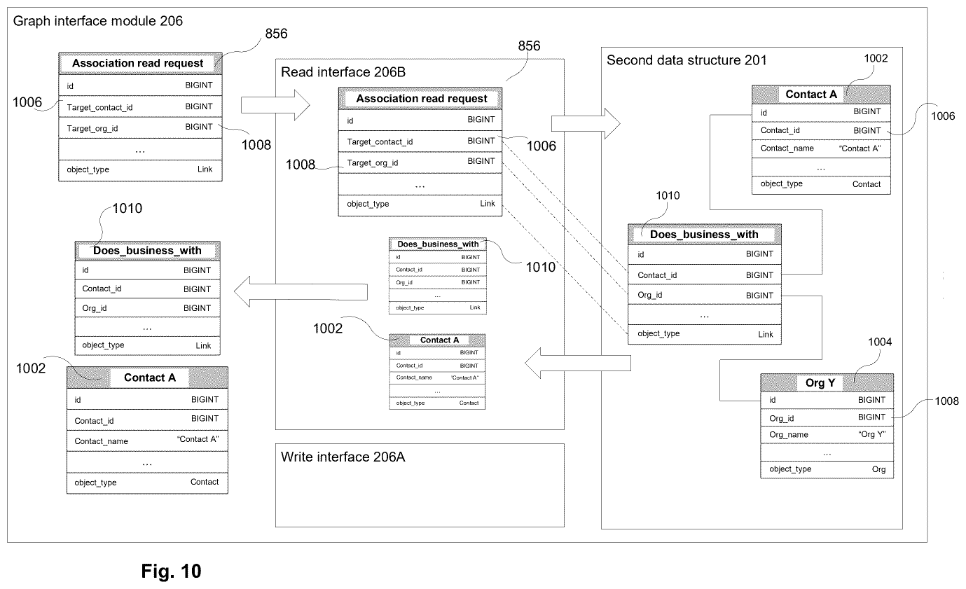

In one example shown in FIG. 10, where the first object 816 is a contact object 1002, and the second object 840 is an organisation (org) object 1004, the target association information 858 will include unique identifiers 1006, 1008 for each of the contact object 1002 and the organisation object 1004. These unique identifiers 1006, 1008 may come from the respective vertex tables of the first and second objects 1002, 1004. The entries in the vertex tables which contain the unique identifiers 1006, 1008 may be referred to as keys. The read interface 206B identifies the existence of any edge tables that include both the contact identifier 1006 of the contact object 1002 and the organisation identifier 1008 of the organisation object 1004. When the read interface does not identify an association object 1010 in the form of an edge table within the second data structure 201 including both the contact identifier and the organisation identifier, it is determined that no association 838 exists between the contact object 1002 and the organisation object 1004. If the read interface does identify an edge table that includes both the contact identifier 1006 and the organisation identifier 1008, the contact object 1002 is returned. In some embodiments, the association object 1010 is returned. In some embodiments, the contact object 1002 and the association object 1010 are returned.

In some embodiments, when the graph interface module 206 determines that no association information 850 exists between the first entity object 816 and the second entity object 840, a new association 838 between the first object 816 and the second object 840 is written to the second data structure 201. By updating the second data structure 201 to include new associations when it determines a potential gap in the structure 201 information, this enables the structure to be continually updated as needed. Updating on the basis of identified or inferred associations which do not yet exist within the structure creates a feedback loop which enables the data structure 201 to be dynamically updated in real time to reflect newly identified associations. This means that the data structure 201 continually contains up-to-date and reflects relevant information which can be used in related queries.

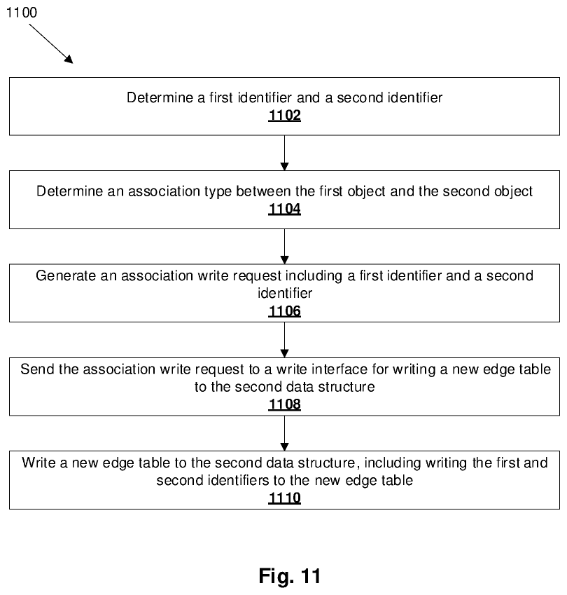

FIG. 11 is a process flow diagram of a method 1100 of writing a new association between a first object and a second object to a second data structure 201, according to some embodiments. The method 1100 may be implemented by the processor(s) 414 of the system 402 executing code stored in memory 416.

The graph interface module 206 generates new association information 1120 indicative of an association 1122 between the first entity object 816 and the second entity object 840. New association information 1120 may include the first entity identifier 824 and the second entity identifier 860. In the method of 1100, at 1102, the first identifier 824 and second identifier 860 are determined, and at 1104, an association type 1126 is determined which indicates the type of association between the first object 816 and the second object 840. The association type 1126 may be included in the new association information 1120. The new association information 1120 may be inferred, for example, by an inference engine 205, based on query actions taken by the graph interface module 206, or by actions taken within the system, such as using the system to reconcile a transaction on an accounting platform, for example through a transaction reconciliation module. In some embodiments, new association information 1120 may be generated by inferring that the first object 816 is associated with the second object 840 by an inferred association type 1128 based on the target object read request 802. For example, the inferred association type 1128 may be a contact association. The association information 1120 may be manually input by a user, such as where a user wishes to define a new relationship between their organisation and a contact entity, or where the user wishes to add a contact to a list of contacts associated with their organisation.

At 1106, the graph interface module 206 generates an association write request 1124 to write the new association information 1120 to the second data structure 201. In some embodiments, the association write request includes the first object identifier 824, the second object identifier 860, and the association type 1126. At 1108, the graph interface module 206 sends the association write request 1124 to a write interface 206A of the graph interface module 206 for writing to one or more tables of the second data structure 201. Writing the new association information 1120 to the data structure 201 includes extracting the first and second object identifiers from the respective first and second entity objects, and then at 1110, writing the first and second object identifiers 824, 860 to a new edge table 1132 within the second data structure 201, the edge table 1132 being indicative of the new association 1122 between the first object 816 and the second object 840. In some embodiments, the association write request 1124 may not include the type of association for the edge table, and only provides a record that the first and second object are associated in some way.

In some embodiments, the write interface 206A is configured to write multiple associations between multiple objects in a single write request. In further embodiments, the graph interface module 206 is configured to generate multiple write requests for association objects or edge tables for one or more entities at the same time. Multiple write requests may be sent in batches to update to the second data structure 201. For example, providing the association write request to the write interface 206A of the graph interface module 206 may include determining a plurality of association write requests 862 to be written to the structure 201, collating the plurality of association write requests 862 as a batch write request 864, and providing the batch write request 864 to the write interface 206A of the graph interface module 206.

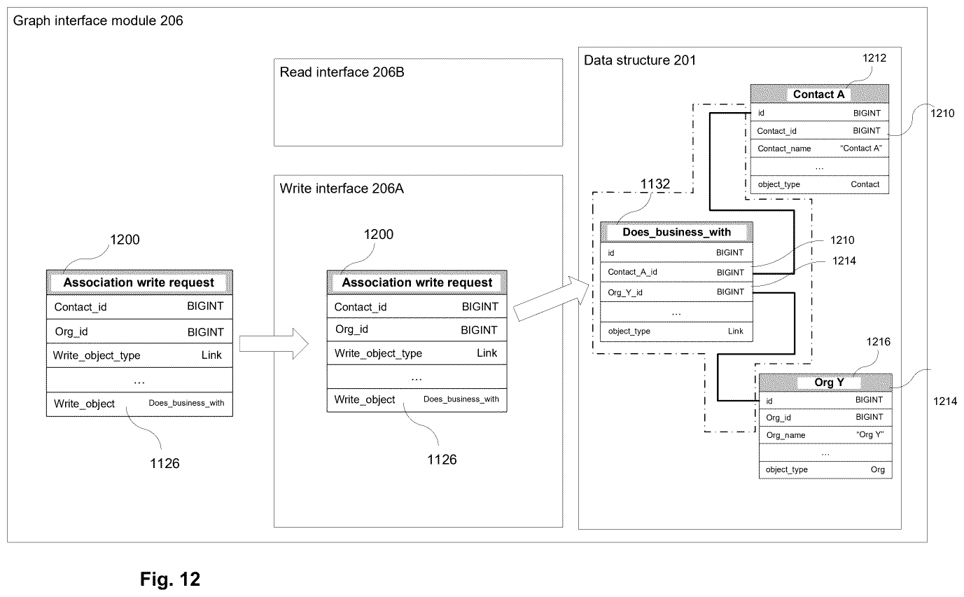

In one example shown in FIG. 12, the association write request 1200 is generated using the first object identifier 824 of a first object 816 and the second object identifier 860 of a second object 840. The first and second object identifiers 824, 860 are a contact key 1210 of a contact object 1212 and an org key 1214 of an org object 1216 respectively. The association write request 1200 also includes an association type 1126 under the attribute “Write_object” having a value of “does_business_with”. It will be appreciated that the any appropriate attribute and/or naming convention may be used to define the association type. This indicates that that a new edge table 1132 written to the second data structure 201 will define a relationship of “does business with” between the contact object 1212 and the organisation object 1216. The association write request 1200 is sent to the write interface 206A to write the new edge table 1132 to the second data structure 201. The write interface 206A determines the contact object key 1210 and org object key 1214 that should be written to the new edge table 1132. The contact and org keys 1210, 1214 may be determined from the tables of the respective contact and org objects 1212, 1216. The write interface 206A then writes the contact and org object keys 1210, 1214 to a new edge table 1132 of the second data structure 201, where the edge table is indicative of the “does_business_with” association between the contact object 1212 and the organisation object 1216.

In some embodiments, the graph interface module may be in communication with a business register interface module, where all or part of the methods described herein may be carried out by the graph interface module 206 and/or the business register interface module 504.

In some embodiments, a business register module configured to perform the method may include a business register builder module 502, and a business register interface module 504 in communication with the graph interface module 206. The business register interface module 504 includes a business register write interface 504A in communication with the write interface 206A of the graph interface module 206, a business register data structure 506 defined by at least part of the structure 201, and a business register read interface 504B in communication with the read interface 206B of the graph interface module 206. The business register data structure 506 is configured to be updated by the business register write interface 504A.

In further embodiments, the graph interface module may be a business register interface module 504, and the methods described herein to update the first or second data structures 201, 506 may be performed by a business register module 422. The business register module 422 may be configured to perform the method of updating a data structure 201 described herein. For example, the graph interface module 206 may be a business register interface module 504. In some embodiments, the data structure 201 may be the business register data structure 506. The business register interface module is configured to determine whether an association exists between two objects in the business register and, if not, update the business register by writing the new association information to define a relationship between two objects (for example, a contact object and an organisation object) to the business register data structure 506.

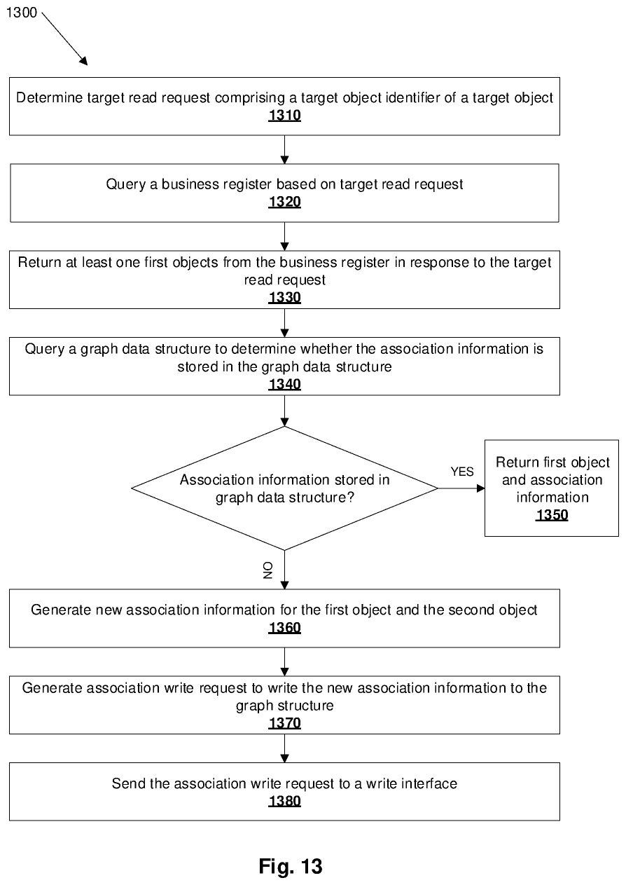

FIG. 13 is a process flow diagram of a method of updating a data structure. A method of updating a data structure includes determining a target object read request 802 for querying a business register 150 (1310), the target object read request comprising a target entity identifier 810 of a target object 804. The target object read request is then used to query the business register 150 for determining a first entity object identifier 824 of a first entity object 816 (1320). A response is provided to the target object read request 802 which includes at least the first entity object 816 (1330). Association information is then identified between the first entity object 816 and a second entity object 840 (1340). A second data structure in the form of a graph data structure is then queried to determine whether the association information between the first entity object 816 and the second entity object 840 is stored in the graph data structure. Responsive to no association information being identified between the first and second objects in the graph data structure, new association information 1120 is generated which is indicative of an association between the first entity object 816 and the second entity object 840 (1360). The new association information may include the first entity identifier 824 of a first entity object 816 and a second entity identifier 860 of the second entity object 840. An association write request 1124 is generated to write the new association information 1120 to the graph data structure (1370), and the association write request is provided to the write interface 504A of the business register interface module 504 (1380).

The methods of determining target objects within a business register, determining association information in a graph structure and updating the graph structure may be used in conjunction with a transaction reconciliation module to reconcile financial transactions. For example, in some embodiments, a financial statement may be used by the transaction reconciliation module to reconcile financial transactions against invoices issued by an Organisation. The transaction reconciliation module may be configured to extract candidate information from data lines in a financial statement. The candidate information may relate to potential entity attributes, for example, the extracted information from a statement line may be a string value which represents a potential Contact name. The transaction reconciliation module then generates a target object read request to query a business register for the potential Contact name. The potential contact name is matched to canonical objects and/or their associated aliases to identify a Contact to which the potential contact name is a match. Once an object is matched with the potential contact name, the object is returned to the transaction reconciliation module, and the transaction reconciliation module can use the object to reconcile a financial statement line against an issued invoice. For example, where a Contact is identified within the business register that matches the potential contact name extracted from the statement line, the transaction reconciliation module checks the Contact against invoices issued by the Organisation, and reconciles the transaction between the Contact and the Organisation. Where the statement line includes financial data, for example, a financial amount, the transaction reconciliation module may also compare the financial amount on the statement line with the financial amount from the issued invoice as part of the reconciliation process.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method comprising:
determining a target object read request for querying a first data structure, the target object read request comprising a target identifier of a target object;
determining a first object identifier of a first object in the first data structure based on the target identifier;
providing a response to the target object read request, wherein the response includes at least the first object;
determining association information between the first object and a second object;
determining whether the association information between the first object and the second object is stored in a second data structure; and
responsive to no association information being identified between the first object and the second object in the second data structure:
generating new association information indicative of the association between a first entity object and a second entity object, the new association information including the first identifier of the first object and a second identifier of the second object;
generating an association write request to write the new association information to the second data structure;
providing the association write request to the second data structure.

2. The method of claim 1, wherein responsive to determining that there is no first object identifier associated with the target identifier in the first data structure, determining an object identifier using a fuzzy matching technique to determine a similarity score between the target identifier and an object identifier, and identifying the object identifier as being associated with the target identifier when the similarity score is above a threshold value.

3. The method of claim 1, wherein after providing a response to the target object read request including the first object, the method further includes: performing validation that the first object corresponds with the target object.

4. The method of claim 1, wherein the first and/or second data structures are graph structures; and/or
wherein the first data structure is a business register, and wherein the business register comprises at least one canonical first object and a set of aliases associated with the at least one first object; and/or
wherein the second data structure is in communication with the first data structure.

5. (canceled)

6. (canceled)

7. The method of claim 4, wherein determining the first object identifier based on the target identifier comprises comparing the target identifier with the at least one canonical first object and/or the set of aliases associated with the at least one first object; and/or
wherein the target identifier is extracted from an external data source.

8. The method of claim 1, wherein determining the target object read request comprises:
receiving the target object read request from a transaction reconciliation module; and
providing the response to the target object read request comprises sending the response to the transaction reconciliation module to allow the transaction reconciliation module to reconcile a transaction using the first object.

9. (canceled)

10. (canceled)

11. The method of claim 1, wherein the first object and/or the second object is an entity object, and the target identifier is a candidate entity attribute; and/or
wherein the first object is a contact object; and/or
wherein the second object is an organisation object.

12. (canceled)

13. (canceled)

14. The method of claim 1 wherein determining whether the association information between the first object and the second object is stored in a second data structure, comprises:
generating an association read request, the association read request comprising target association information between the first object and the second object, the target association information including first and second identifiers of the respective first and second objects;
identifying one or more edge tables in the second data structure that include the target association information;
wherein responsive to no edge tables being identified within the second data structure that include the target association information, determining no association information between the first object and the second object is stored in the second data structure; and
responsive to one or more edge tables being identified within the second data structure that include the target association information, determining association information between the first object and the second object is stored in the second data structure; and
returning at least the first object;
wherein identifying one or more edge tables in the second data structure that include the target association information includes querying all edge tables in the second data structure that include at least the first identifier to determine if the edge tables contain the second identifier.

15. (canceled)

16. The method of claim 14, wherein the target association information includes a target association identifier indicating an association type, and
wherein the target association identifier is a contact association type.

17. (canceled)

18. The method of claim 1, further including:
responsive to association information being identified between the first object and the second object in the second data structure, providing a response containing the association information and the first entity object.

19. The method of claim 1, wherein generating new association information indicative of the association between the first object and the second object includes:
inferring that the first object is associated with the second object by an inferred association type based on the target object read request,
wherein the inferred association type is a contact association type.

20. (canceled)

21. The method of claim 1, wherein providing the association write request to the second data structure comprises:
providing the association write request to a write interface in communication with the second data structure for writing to one or more tables of the second data structure;
wherein providing the association write request to the write interface comprises:
determining a plurality of association write requests to be written to a graph structure;
collating the plurality of association write requests as a batch write request; and
providing the batch write request to the write interface of a graph interface module.

22. The method of claim 21, wherein the association write request includes a plurality of association write requests.

23. (canceled)

24. The method of claim 1, further comprising:
writing the new association information to the second data structure by:
determining first and second object keys from the respective first and second objects; and
writing the first and second object keys to an edge table of the second data structure, the edge table being indicative of the association between the first object and the second object.

25. The method of claim 24, wherein the first and second keys are extracted from first and second tables of the respective first and second objects.

26. The method of claim 1, wherein the first object identifier and/or the second object identifier is an entity identifier, wherein the entity identifier is a string value.

27. (canceled)

28. The method of claim 1, wherein the method further includes determining a target object based on a request from a user via a user interface.

29. The method of claim 28, wherein the user interface is a user interface provided by an accounting platform.

30. (canceled)

31. (canceled)

32. A system comprising:
one or more processors; and
memory comprising computer executable instructions, which when executed by the one or more processors, cause the system to perform the method of claim 1.

33. A computer-readable storage medium storing instructions that, when executed by a computer, cause the computer to perform the method of claim 1.
